(19) United States
(12) Patent Application Publication
(10) Pub. No.: US 2007/0268150 A1
(43) Pub. Date: Nov. 22, 2007

(54) Portable Signalling Lantern

(76) Inventor: Leigh Hugh Fraser, Victoria (AU)

Correspondence Address: EDWIN D. SCHINDLER, FIVE HIRSCH AVENUE, P.O. BOX 966, CORAM, NY, 11727-0966, US

(21) Appl. No.: 11/571,137

(22) PCT Filed: Jun. 29, 2005
(86) PCT No.: PCT/AU05/00956

§ 371 Date: Apr. 26, 2007

(30) Foreign Application Priority Data
Jun. 29, 2004 (AU) 2004903530
Aug. 27, 2004 (AU) 2004904921

(51) Int. Cl. G08B 5/36; F21L 4/02

(52) U.S. Cl. 340/815.63; 340/815.67; 362/184

(57) ABSTRACT

A portable signaling lantern includes a body having a device for hand-carrying the lantern. A housing is included which defines a battery chamber and includes a lamp on the face of the housing for illuminating an area in the vicinity of the housing with at least two closed loop arrays of solid state lamp devices disposed on the face of the housing about the lamp. The respective closed loop arrays of solid state lamp devices are arranged one inside the other and, when activated, have collective color outputs that are clearly visually distinguishable from a remote viewing position of greater than 1 km from the lantern. The body of the lantern includes a device for selectively activating the lamp or either of the solid state lamp devices utilizing one or more batteries in the battery chamber to power the lamp or array.

### AREA OF THE INVENTION

This invention relates to the area of portable signalling lanterns and in particular to such a lantern for use, by way of example, in railway operations. While for convenience sake the invention is discussed here in relation to railway operations it is not limited to this application.

### BACKGROUND TO THE INVENTION

Conventional railway signalling lanterns typically have a battery operated lamp able to provide illumination in the vicinity of the person carrying the lantern, and a red and green filter moveable from a retracted position to an operative position in front of the lamp relative to an observer at a distance along the track. More elaborate lamps are provided with both red and green filters positionable to is provide either a red or green signal.

Personnel in shunting yards use these lanterns to send stop or go signals to drivers aboard locomotives from positions where strings of cars are being backed and coupled to other cars. When used trackside, for example, to warn approaching locomotive drivers of the presence of a works team or other temporary hazard it is essential that the driver can see the signal at least 1 km away and preferably up to 2 km away.

A known signalling torch has a conventional centre lamp comprising an incandescent or halogen globe within a projecting reflector, with a ring of alternate red and green light emitting diodes about the reflector. This device reflects a trend to substitute or augment conventional incandescent and halogen lamps with arrays of high intensity light emitting diodes (LEDs). These have the advantage of long life and low power usage, but the disadvantages of relatively limited intensity for illumination purposes. In addition the output beam has a relatively narrow convergence angle compared with the output of conventional incandescent and halogen globes.

### Outline of the Invention

It is an object of this invention to provide an improved lamp employing solid state lamp technology which has an increased visibility at distance when compared with previous such lamps.

The invention provides a portable signalling lantern which includes
a body provided with means for hand carrying and having a housing which defines a battery chamber;
lamp means on the housing actuable for illuminating a zone in the vicinity of the housing;
at least two closed loop arrays of solid state lamp device disposed on said housing about said lamp means, which respective arrays are arranged one inside the other, and when activated have collective colour outputs that are clearly visually distinguishable from a remote viewing position at a predetermined displacement from the arrays; and
means on said body to selectively activate said lamp means or either of said arrays of solid state lamp devices utilising one or more batteries in the chamber to power the lamp means or array.

It is preferred that the solid state lamp devices be light emitting diodes (LEDs).

In one application two closed loop arrays respectively comprise red and green solid state lamp devices whereby the lantern may be deployed to display a stop or go signal to a remote viewer. Preferably the array of red lamp devices is inside the array of green lamp devices.

In another application two closed loop arrays respectively comprise red and blue solid state lamp devices, and the activation means preferably flashes the two colours alternately. Such a lamp configuration has particular utility as a roadside or other incident signalling lantern e.g. to warn approaching drivers of an accident or other hazard. Again the red lamp devices may be inside the blue lamp devices.

In a preferred arrangement the closed loop arrays are circular arrays and may be concentric with said lamp means.

The lamp means typically includes an incandescent lamp, e.g. a halogen lamp but may comprise one or more arrays of solid state lamp devices such as LEDs.

The solid state lamp devices of the respective arrays are preferably mutually offset to define a compact geometric configuration.

Preferably the solid state lamp devices are surface mounted on an annular face generally in a plane normal to the axis of symmetry of the lantern with respect to a remote viewer.

Advantageously the solid state lamp devices of each array are variably inclined so as to widen the effective divergence angle of the composite beam emitted by the lamp devices of the respective arrays.

More than two closed loop arrays may be provided. For example a third array may comprise amber LEDs.

Preferably for use in signalling operations such as railway operations the array of red lamp devices is visible 1 to 1.5 km away from the lantern.

For particular applications such as for warning of an accident or hazard the activation means may flash one or more of the colours in any predetermined pattern.

For particular applications the lantern body may carry an arrow or other directional symbol visible to an approaching viewer. The arrow or other directional symbol may be reflective or able to be illuminated (and optionally flashing) or fluorescent to enhance its visibility.

In order that the invention may be more readily understood we will describe by way of non limiting example a specific embodiment of the invention with reference to the accompanying drawings.

### BRIEF DESCRIPTION OF THE DRAWING FIGURES

FIG. 1 is a front perspective view of a portable signalling lantern for use in railway shunting and track works applications;

FIG. 2 is a cross-sectional diagram depicting the benefit of the inner LED array being the red LED array;

FIG. 3 is an optical diagram showing the variable inclination of the LED's of each circular array as seen in FIG. 1;

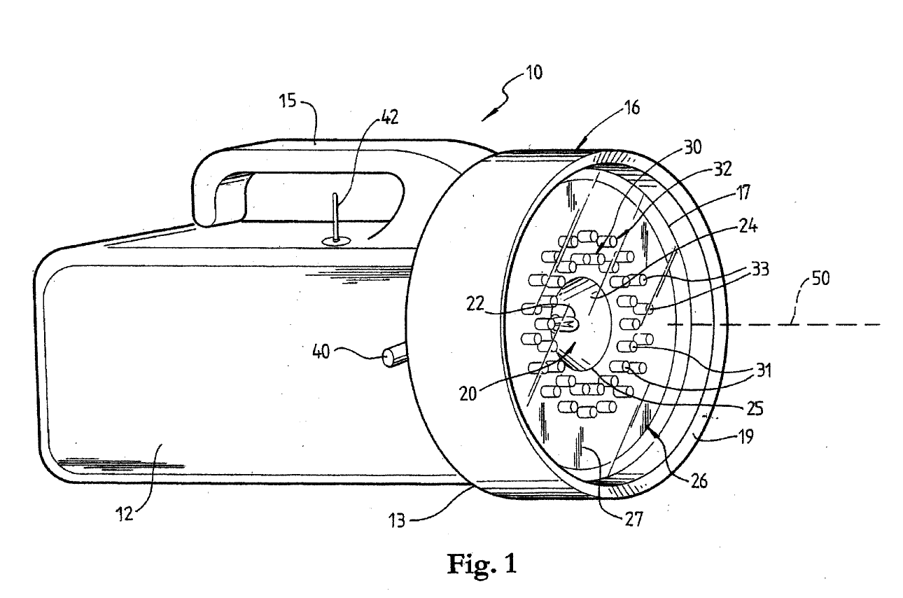

### DESCRIPTION OF EMBODIMENTS OF THE INVENTION

The illustrated portable signalling lantern 10 is similar in its general physical appearance to existing lanterns used as powerful illuminating flashlights. The lantern includes a moulded open ended body 12 of a plastics material chosen to render the body sturdy and shock resistant. Body 12 includes an upper projecting handle 15 but serves primarily to define a chamber (not shown) for one or more long life rechargeable batteries of suitable voltage. The body further has a sub chamber to house two or more non-rechargeable batteries as a back up power supply in the event that the main rechargeable power supply runs low in the field.

A front closure cap 16 has a transparent cover 17 with a protective projecting rim 19 and is releasably engageable with the open end 13 of body 12 by way of any variety of conventional fitting such as threaded, bayonet or snap engageable components and the like. Cap 16 retains a central illumination lamp 20 comprising a cooperative assembly of a halogen incandescent globe 22 and a conical reflector 24. In another embodiment of the invention however it is preferred that the halogen incandescent globe be replaced with a white LED display.

Disposed about the rim 25 of reflector 24 is an annular baffle 26, which in turn concentrically mounts on its forwardly facing surface 27, a pair of closed loop arrays 30, 32 of solid state lamp devices 31,33. Surface or face 27 is substantially in a plane normal to the axis of symmetry 50 of the lantern with respect to the remote viewer. Arrays 30,32 are circles or rings and the solid state lamp devices comprise an inner ring of green LEDs 31 and an outer ring of red LEDs 33.

In a preferred arrangement baffle 26 is a segment of printed circuit board having power supply circuitry and contacts to which the LEDs are fixed. Especially in this case it is preferred that the LEDs of the respective arrays to be mutually offset so as to provide a geometrically compact configuration. Appropriate internal contacts and wiring include a master on/off switch 40 and a three position toggle selector switch 42 by which a hand grasping the upper handle 15 of body 12 may finger select one of lamp 20 and LED arrays 30,32 for activation. If lamp 20 is activated, globe 22 illuminates a zone in the vicinity of the lantern to an extent determined by the power of the lamp assembly and the power supply. If one of the LED arrays is selected the lantern projects a red or green (stop or go) signal as a composite light beam emitted forwardly through the transparent cover 17 of cap 16.

LEDs 31, 33 and their number are chosen so that, when activated, the arrays have collective colour outputs that are clearly visually distinguishable from a remote viewing position at a predetermined distance from the arrays being at least 1 km to 1.5 kms particularly where the lantern is a railway signalling lantern. It is found that the provision of respective discrete closed loop arrays of LED's is an effective means of optimising the clarity of the signal at distances greater than 1 km from the lantern. Preferably the inner array is a ring of radius in the range 25-40 mm at the centres of the LED devices, and there are about 15 to 25 LED devices in the ring. The outer array is then typically at a radius 5 mm larger with one additional LED.

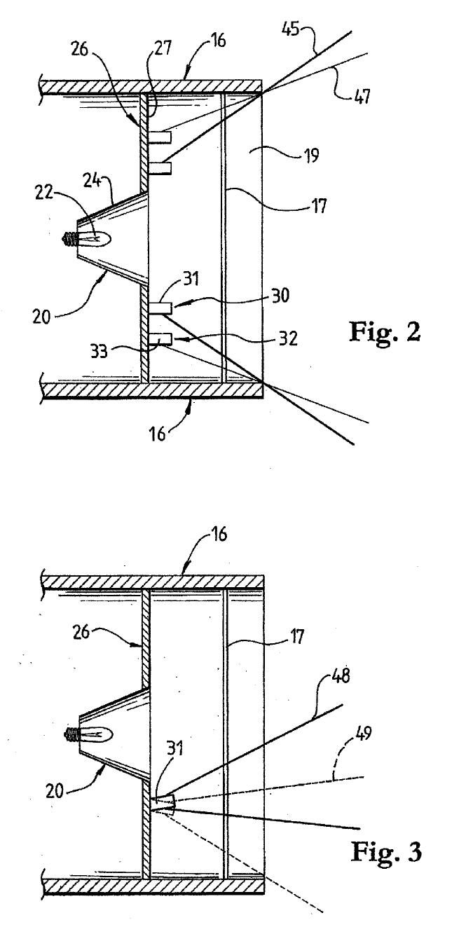

It is found preferable to have the green ring on the inside of the red ring because in general the red signal will be the more critical and the wider diameter of this beam is preferred. This is illustrated diagrammatically in FIG. 2. To further widen the angle of divergence of the red inner ring, and hence enhance the visibility of the signal at a distance, the LED devices are alternately tilted slightly oppositely to the normal to the surface 27, i.e. inwardly and outwardly relative to the central axis of symmetry 50. This effect is illustrated with is some exaggeration for illustrative purposes in FIG. 3, in which the respective diverging beams emitted by successively oppositely tilted LEDs is depicted at 48,49.

In a second embodiment of the invention an inner circle of 20 green LEDs spaced 70 mm apart is provided. In a second outer circle Amber LEDs spaced 85 mm apart are provided and outside this a circle of red LEDs spaced 90 mm apart is provided. The lantern has a switch which enables a user to push the switch forward for red, central for amber and back for green. The positioning of the coloured LEDs is such as to reduce a flaring effect of any particular LED and hence provide a portable signalling device which can be seen from a minimum distance of 1.5 km.

While we have described herein one specific embodiment of the invention it is envisaged that other embodiments of the invention will exhibit any number of and any combination of the features of those previously described and it is to be understood that variations and modifications in this can be made without departing from the spirit and scope of the invention.

1-15. (canceled)

16. A portable signaling lantern, comprising:
a body including a housing having a battery chamber;
a lamp on a face of said housing actuable for illuminating a zone proximate of said housing;
at least two closed loop arrays of solid state lamp devices disposed on said face of said housing about said lamp, said at least two closed loop arrays of solid state lamp devices being arranged one inside another and, when activated, have collective color outputs that are visually distinguishable from a remote viewing position at a predetermined displacement from said at least two closed loop arrays of said solid state lamp devices; and,
means for selectively activating said lamp or any of said at least closed loop arrays of said solid state lamp devices utilizing a battery located in said battery chamber for powering said lamp or one closed loop array of said at least two closed loop arrays of said solid state lamp devices.

17. The portable signaling lantern according to claim 16, wherein said solid state lamp devices are light emitting diodes.

18. The portable signaling lantern according to claim 16, wherein said at least two closed loop arrays of said solid state lamp devices, respectively, comprise a red solid state lamp array and a green solid state lamp array, so that said portable signaling lantern is deployable for displaying a “stop” or “go” signal to a remote viewer.

19. The portable signaling lantern according to claim 18, wherein said green solid state lamp array is inside said array of red solid state lamp array.

20. The portable signaling lantern according to claim 19, wherein said red solid state lamp array are alternately tilted slightly oppositely to normal to said face of said housing.

21. The portable signaling lantern according to claim 18, wherein said red solid state lamp array, when activated, provides a signal visible at a distance greater than 1 km from said portable signaling lantern.

22. The portable signaling lantern according to claim 16, wherein said lamp is an incandescent light.

23. The portable signaling lantern according to claim 16, wherein said lamp is an LED display.

24. The portable signaling lantern according to claim 16, wherein said at least two closed loop arrays of said solid state lamp devices are circular arrays that are substantially concentric with said lamp.

25. The portable signaling lantern according to claim 24, wherein said solid state lamp devices of respective said circular arrays are mutually offset for defining a compact geometric configuration.

26. The portable signaling lantern according to claim 24, wherein said solid state lamp devices of each circular array of said circular arrays are variably inclined for widening an effective divergence angle of a composite beam emitted by said solid state lamp devices of respective said circular arrays.

27. The portable signaling lantern according to claim 16, wherein said at least two closed loop arrays of solid state lamp devices is at least three closed loop arrays of said solid state lamp devices that display at least three different colors of light.

28. The portable signaling lantern according to claim 16, further comprising means for displaying a warning signal.

29. The portable signaling lantern according to claim 16, wherein said means for selectively activating said lamp or any of said at least closed loop arrays of said solid state lamp devices is capable of flashing at least one color of light in a predetermined pattern of light.

30. The portable signaling lantern according to claim 16, wherein said collective color outputs are visible from a distance greater than 1.5 km from said portable signaling lantern.

31. The portable signaling lantern according to claim 16, wherein said body includes means for hand-carrying by a user.
